(19) United States
(12) Patent Application Publication
(10) Pub. No.: US 2018/0268288 A1
(43) Pub. Date: Sep. 20, 2018

(54) Neural Network for Steady-State Performance Approximation

(71) Applicant: General Electric Company, Schenectady, NY (US)

(72) Inventors: John Lawrence Vandike, Cincinnati, OH (US); Kenneth Lee Dale, Fairfield, OH (US)

(21) Appl. No.: 15/458,340

(22) Filed: Mar. 14, 2017

(51) Int. Cl. G06N 3/08; F01D 21/00; B64D 45/00; G07C 5/08

(52) U.S. Cl. CPC G06N 3/08; F01D 21/003; B64D 45/00; F05D 2270/709; F05D 2220/323; F05D 2270/20; G07C 5/0816

(57) ABSTRACT

Systems and methods that include and/or leverage a neural network to approximate the steady-state performance of a turbine engine are provided. In one exemplary aspect, the neural network is trained to model a physics-based, steady-state cycle deck. When properly trained, novel input data can be input into the neural network, and as an output of the network, one or more performance indicators indicative of the steady-state performance of the turbine engine can be received. In another aspect, systems and methods for approximating the steady-state performance of a “virtual” or target turbine engine based at least in part on a reference neural network configured to approximate the steady-state performance of a “fielded” or reference turbine engine are provided.

### FIELD

The present subject matter relates generally to turbine engines. More particularly, the subject matter relates to systems and methods for approximating the steady-state performance of one or more turbine engines.

### BACKGROUND

Steady-state engine performance of aircraft turbine engines has conventionally been modeled by physics-based steady-state cycle decks, or numerical representations or characterizations of an engine's performance while operating in steady-state flight conditions. While physics-based models can generate accurate representations of steady-state engine performance, they are typically computationally intensive due to the vast number of complex, physics-inspired algorithms that need be processed; thus, engine performance results are generated relatively slowly and computing devices with more processing power are generally needed, leading to long lead times and the necessity for more expensive computing equipment.

In addition, physics-based models are generally not robust to out-of-range data points and generally require supervision (i.e., human intervention) to run smoothly. Moreover, many times physics-based models require dedicated applications or software for executing the models, which are generally not language/operating system agnostic. This presents challenges when engine manufacturers deliver or share engine performance data with aircraft manufacturers. Accordingly, physics-based models configured to model steady-state engine performance may be challenging to use and deploy.

In another respect, to numerically represent the engine performance of a new turbine engine design or non-fielded turbine engine, many times physics-based models need to be redeveloped or substantially overhauled in order to accurately model the engine performance of the new or non-fielded turbine engine. As a result, significant effort and time may be required to develop these physics-based models for new or non-fielded turbine engines.

Therefore, improved systems and methods for approximating the steady-state performance of one or more turbine engines would be useful. Additionally, a steady-state performance model that can be readily correlated to new engine platforms would be beneficial.

### BRIEF DESCRIPTION

Exemplary aspects of the present disclosure are directed to methods and systems for approximating the steady-state performance of one or more turbine engines. Aspects and advantages of the invention will be set forth in part in the following description, or may be obvious from the description, or may be learned through practice of the invention.

One exemplary aspect of the present disclosure is directed to a computer-implemented method for steady-state performance approximation of a turbine engine. The method includes receiving, by one or more computing devices, a data set that includes one or more operating parameters indicative of the operating conditions of the turbine engine during operation. The method also includes inputting, by the one or more computing devices, at least a portion of the data set into a neural network. The method further includes receiving, by the one or more computing devices, one or more performance indicators of the turbine engine as an output of the neural network, wherein the neural network is configured to approximate the steady-state performance of the turbine engine.

In various embodiments, the neural network is trained based at least in part on a training data set of a steady-state cycle deck.

In some various embodiments, the steady-state cycle deck is a physics-based model.

In still other embodiments, the neural network is trained based at least in part on the training data set of the steady-state cycle deck by: inputting, by the one or more computing devices, at least a portion of the training data set into the neural network, the training data set indicative of steady-state operating conditions of the turbine engine during operation, the training data set includes one or more cycle deck inputs and one or more cycle deck outputs of the steady-state cycle deck, each of the cycle deck outputs corresponding to one or more of the cycle deck inputs; receiving, by the one or more computing devices, one or more performance indicators of the turbine engine as an output of the neural network, and training, by the one or more computing devices, the neural network based at least in part on an error delta that describes a difference between the output of the neural network and the cycle deck output that corresponds to one or more of the cycle deck inputs input into the neural network.

In still some various embodiments, the one or more operating parameters include at least one of: a fan speed, an altitude, an ambient temperature, and a Mach number.

In still some various embodiments, the turbine engine is mounted to or integral with a rotorcraft, and wherein the one or more operating parameters include at least one of: a forward air speed, a requested torque, and a requested power.

In still other various embodiments, the one or more performance indicators include at least one of: a mass flow, one or more station temperatures, one or more station pressures, and a core speed.

In still other various embodiments, after receiving the one or more performance indicators of the turbine engine as an output of the neural network, the method further includes providing, by the one or more computing devices, the one or more performance indicators to a damage model.

In still other various embodiments, the turbine engine is mounted to or integral with an aircraft, and wherein after receiving the one or more performance indicators of the turbine engine as an output of the neural network, the method further includes: providing, by the one or more computing devices, the one or more performance indicators to a vehicle computing device located onboard the aircraft.

Another exemplary aspect of the present disclosure is directed to a computer-implemented method for training a neural network configured to approximate the steady-state performance of a turbine engine. The method includes inputting, by the one or more computing devices, at least a portion of a training data set into a neural network, the training data set indicative of steady-state operating conditions of the turbine engine during operation, the training data set that includes one or more cycle deck inputs and one or more cycle deck outputs of a steady-state cycle deck, each of the cycle deck outputs corresponding to one or more of the cycle deck inputs. The method also includes receiving, by the one or more computing devices, one or more performance indicators of the turbine engine as an output of the neural network, wherein the output of the neural network is configured to approximate the steady-state performance of the turbine engine. The method further includes training, by the one or more computing devices, the neural network based at least in part on an error delta that describes a difference between the output of the neural network and the cycle deck output that corresponds to one or more of the cycle deck inputs input into the neural network.

In various embodiments, after training, the method is repeated at least until the error delta that describes a difference between the output of the neural network and the cycle deck output that corresponds to one or more of the cycle deck inputs is about within a threshold percentage.

In still other various embodiments, the threshold percentage is plus or minus one (1) percent.

In other various embodiments, after training, the method includes receiving, by one or more computing devices, a validation data set indicative of steady-state operating conditions of the turbine engine during operation, the validation data set includes one or more cycle deck inputs and one or more cycle deck outputs of the steady-state cycle deck, each of the cycle deck outputs corresponding to one or more of the cycle deck inputs. The method also includes inputting, by the one or more computing devices, at least a portion of the cycle deck inputs of the validation data set into the neural network. The method further includes receiving, by the one or more computing devices, one or more performance indicators of the turbine engine as an output of the neural network. The method also includes determining, by the one or more computing devices, an error delta that describes a difference between the output of the neural network and the cycle deck output that corresponds to one or more of the cycle deck inputs of the validation data set input into the neural network. Moreover, the method further includes determining, by the one or more computing devices, whether the error delta that describes a difference between the output of the neural network and the cycle deck output that corresponds to one or more of the cycle deck inputs is about within a threshold percentage.

In other various embodiments, the neural network includes an input layer, a hidden layer having one or more hidden layer nodes, and an output layer; and wherein, if the error delta is not about within the threshold percentage, the method further includes adjusting, by one or more computing devices, the number of the one or more hidden layer nodes.

In still other various embodiments, the cycle deck inputs include one or more operating parameters, wherein the one or more operating parameters include at least one of: a fan speed, an altitude, an ambient temperature, a Mach number, a forward air speed, a requested torque, and a requested power.

Another exemplary aspect of the present disclosure is directed to a method for approximating the steady-state performance of a target turbine engine based at least in part on a reference neural network configured to approximate the steady-state performance of a reference turbine engine. The method includes converting, by one or more computing devices, a reference data set into a target data set, the reference data set includes one or more operating parameters indicative of steady-state operating conditions of the reference turbine engine during operation, and the target data set indicative of an approximation of steady-state operating conditions of the target turbine engine after being converted. The method also includes inputting, by one or more computing devices, at least a portion of the target data set into the reference neural network. The method further includes receiving, by one or more computing devices, one or more target performance indicators as an output of the reference neural network, the one or more target performance indicators indicative of the steady-state performance of the target turbine engine.

In various embodiments, the target turbine engine is a non-fielded turbine engine.

In various embodiments, the maximum thrust of the target turbine engine is about within 20,000 lb_{f} of the maximum thrust of the reference turbine engine.

In other various embodiments, the maximum thrust of the target turbine engine is about within 15,000 lb_{f} of the maximum thrust of the reference turbine engine.

In other various embodiments, the maximum thrust of the target turbine engine is about within 10,000 lb_{f} of the maximum thrust of the reference turbine engine.

Variations and modifications can be made to these exemplary aspects of the present disclosure.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides exemplary vehicles according to exemplary embodiments of the present disclosure;

FIG. 2 provides a schematic cross-sectional view of an exemplary gas turbine engine according to exemplary embodiments of the present disclosure;

FIG. 3 provides a schematic view of an exemplary system according to exemplary embodiments of the present disclosure;

FIG. 4 provides a workflow diagram of an exemplary system for approximating steady-state performance of an exemplary turbine engine according to exemplary embodiments of the present disclosure;

FIG. 5 provides an exemplary trained neural network according to exemplary embodiments of the present disclosure;

FIG. 6 provides an exemplary computing system according to exemplary embodiments of the present disclosure;

FIG. 7 provides a flow diagram of an exemplary method according to exemplary embodiments of the present disclosure;

FIG. 8 provides a flow diagram for approximating the steady-state performance of a target turbine engine based at least in part on a reference neural network according to exemplary embodiments of the present disclosure; and

FIG. 9 provides a flow diagram of an exemplary method according to exemplary embodiments of the present disclosure.

### DETAILED DESCRIPTION

Reference now will be made in detail to embodiments of the present disclosure, one or more example(s) of which are illustrated in the drawings. Each example is provided by way of explanation of the present disclosure, not limitation of the present disclosure. In fact, it will be apparent to those skilled in the art that various modifications and variations can be made in the present disclosure without departing from the scope or spirit of the present disclosure. For instance, features illustrated or described as part of one embodiment can be used with another embodiment to yield a still further embodiment. Thus, it is intended that the present disclosure covers such modifications and variations that come within the scope of the appended claims and their equivalents.

Exemplary aspects of the present disclosure are directed to systems and methods that include and/or leverage a machine-learned model, such as a neural network, to approximate the steady-state performance of a turbine engine. In particular, the systems and methods of the present disclosure are directed to a computing system and method therefore that includes a neural network configured to output one or more performance indicators of the turbine engine. The performance indicators are indicative of the steady-state performance of the turbine engine. The performance indicators can be used for further analytics and can be input into one or more damage models, for example.

More particularly, in one exemplary aspect, the computing system of the present disclosure can receive or otherwise obtain a data set that includes one or more operating parameters indicative of the operating conditions of the turbine engine during operation. The operating parameters can be obtained from one or more engine or aircraft sensors, data collection devices, or other feedback devices that monitor: conditions of the aircraft, flight conditions, one or more of its engines, or other aircraft or engine components. The operating parameters may include, for example, a fan speed, a Mach number, an altitude, and/or an ambient temperature at the intake of the gas turbine engine over one or more points of a flight envelope. Where the turbine engine is mounted to or integral with a rotorcraft, such as a helicopter, other exemplary operating parameters may include a forward air speed, a requested torque, and/or a requested power.

At least a portion of the data set is input into the machine-learned model. For example, the machine-learned model can be or can otherwise include one or more various model(s) such as, for example, neural networks (e.g., deep neural networks), or other multi-layer non-linear models. Neural networks can include recurrent neural networks (e.g., long short-term memory recurrent neural networks), feed-forward neural networks, convolutional neural networks, and/or other forms of neural networks.

After the data set is input into the machine-learned model, the engine performance computing system receives at least one performance indicator of the gas turbine engine as an output of the machine-learned model. As the machine-learned model is configured to approximate the steady-state performance of the turbine engine, the outputted performance indicators are indicative of the steady-state performance of the turbine engine. The performance indicators or attributes can be, for example, mass flows, station temperatures and pressures, core speeds, etc. and/or other suitable indicators of engine performance, such as e.g., those that are not easily sensed or measured. The generated or outputted performance indicators can then be used for data analytics and input into other models, such as e.g., a damage model, a deterioration model, and/or a lifing model. In other exemplary implementations, the outputted performance indicators can be provided to an onboard vehicle computing system that can be used to make real-time adjustments to one or more inputs of the gas turbine engine, such as e.g., modifying a fuel flow. In some implementations, the machine-learned model can be located and implemented physically onboard the vehicle and can, for example, receive operating parameter data and output performance indicator data in real-time as the vehicle operates.

In another exemplary aspect of the present disclosure, the machine-learned model of an engine performance computing system can be trained to model a steady-state cycle deck, which is a physics-based, thermodynamic model of an engine. Stated alternatively, in some implementations, the machine-learned models of the present disclosure can be configured to be a model of a model (i.e., steady-state cycle deck).

In some implementations, supervised training techniques can be used on a set of labeled training data set. Particularly, to train the machine-learned model to be a model of the steady-state cycle deck, a training computing system, which may be a part of the engine performance computing system or its own dedicated system, receives or otherwise obtains a training data set. The training data set is indicative of steady-state operating conditions of the turbine engine during operation and includes one or more cycle deck inputs and one or more cycle deck outputs of the steady-state cycle deck. Each of the cycle deck outputs correspond to one or more of the cycle deck inputs. Meaning, when one or more cycle deck inputs are input or fed through the steady-state cycle deck, the output or outputs of those inputs is the cycle deck output or outputs. Thus, in some implementations, training data can be generated by providing cycle deck input(s) into a steady-state cycle deck and receiving the corresponding cycle deck output(s).

To train the machine-learned model to approximate the steady-state cycle deck, at least a portion of the training data set is input into the machine-learned model. In particular, the cycle deck inputs are fed into the machine-learned model or model trainer. After inputting a portion of the training data into the model (i.e., one or more cycle deck inputs), at least one performance indicator of the turbine engine is received as an output of the model. As noted above, the performance indicators can be a given value of one of, for example, mass flows, station temperatures and pressures, core speeds, etc.

The model trainer then determines an error delta that describes a difference between the output of the neural network (i.e., the value of the performance indicator) and an expected cycle deck output. After the error delta is determined, the model is trained based at least in part on the error delta. By way of example, where the machine-learned model is constructed as a neural network, a feed-forward/backpropagation technique can be used to adjust the weights of the neural network (e.g., between the input and hidden layer(s), between hidden layer(s), and between the hidden layer(s) and output layer) based upon the error delta. Performing backwards propagation of errors can include performing truncated backpropagation through time. The model trainer or model can perform a number of generalization techniques (e.g., weight decays, dropouts, etc.) to improve the generalization capability of the model being trained.

After an iteration of training (i.e., after one or more weights between layers are adjusted based at least in part upon the error delta), the training process may iterate as necessary until the machine-learned model is constructed with arbitrarily good precision to the training data set. That is, further cycle deck inputs are fed into the model and one or more performance indicators based on those cycle deck inputs are received as outputs of the machine-learned model. Error deltas can be determined by comparing the outputs to the expected cycle deck outputs as described above. In some implementations, the training process iterates until the error delta that describes a difference between the output of the neural network and the expected cycle deck output that corresponds to one or more of the cycle deck inputs is about within plus or minus a threshold percentage (e.g., one (1) percent). In this way, the machine-learned model is constructed within arbitrarily good precision to the training data set.

In some implementations, once the machine-learned model is constructed, a validation data set, which may include cycle deck inputs and corresponding expected cycle deck outputs as well, can be used to validate the model to ensure that the model will behave accurately even when presented with novel input data. Specifically, cycle deck inputs are fed through the machine-learned model. The machine-learned model then outputs one or more performance indicators. The values of the one or more performance indicators are compared to the expected cycle deck outputs of the validation data set such that an error delta can be determined. Based on the error delta, it can be determined whether the model is accurate. The validation process can be repeated with additional novel data to further validate the model. When training is complete and the machine-learned model is validated, the machine-learned model is configured to model a steady-state cycle deck. In this way, when novel data sets are input into the machine-learned model, the outputs of the machine-learned model are approximations of the steady-state performance of the turbine engine.

In another exemplary aspect of the present disclosure, systems and methods that include and/or leverage a machine-learned model to approximate the steady-state performance of a “virtual” or target turbine engine is provided. A virtual or target engine is a turbine engine that exists on or that is simulated on a computer or computer network or can simply be a non-fielded engine. In this way, the machine-learned model may provide a “virtual entry into service” for new turbine engine designs, for example.

Particularly, in one example, systems and methods are provided for approximating the steady-state performance of a target turbine engine (i.e., the virtual turbine engine) by leveraging a reference neural network configured to approximate the steady-state performance of a reference turbine engine (i.e., a fielded turbine engine).

In one aspect, a reference data set is converted into a target data set. The reference data set includes one or more operating parameters indicative of the steady-state operating conditions of the reference turbine engine during operation. These “reference” operating parameters are converted into target operating parameters. In this way, the target data set includes target operating parameters indicative of what the steady-state operating conditions of the target turbine engine would be if the target engine was operating under such conditions.

The reference operating parameters can be converted to target operating parameters by utilizing the steady-state cycle deck used to train the reference neural network and one or more statistical or machine-learning techniques. In one example, a reference fan speed is converted into a target fan speed by utilizing a steady-state cycle deck of the reference turbine engine and a regression technique. First, in this example, a series of thrusts can be selected. Then, the cycle deck can be used to calculate what the fan speed of the reference turbine was to achieve the various selected thrusts. Thus, the fan speeds to achieve the selected thrusts are known for the reference turbine engine. In a similar fashion, the fan speeds for the selected thrusts for the target turbine engine are determined. To do so, the engine specifications of the target turbine engine can be entered into the cycle deck. Specifically, the target engine's fan specifications and relevant engine design characteristics can be input into the cycle deck. The cycle deck can be used to calculate what the fan speed of the target turbine was to achieve the selected thrusts.

Then, once the fan speeds for the reference and target engines are known, a regression analysis can be used to determine the fan speeds for particular thrusts at certain operating conditions over the entire flight envelope. In addition to a regression technique, other techniques such as one or more extrapolation and/or interpolation techniques can be used alone or in combination with the regression technique to infer and or determine target operating parameters based at a least in part on known reference operating parameters and their relationships for one or more points over the flight envelope.

At least a portion of the target operating parameters can be input into the reference neural network. After the target operating parameters are fed through the reference neural network, one or more target performance indicators are received as an output of the reference neural network. The output of the reference neural network (i.e., the target performance indicator) is configured to approximate the steady-state performance of the target turbine engine. In this manner, the steady-state performance of the target turbine engine can be rapidly approximated without need for developing or overhauling a complex physics-based steady-state cycle deck.

The performance indicators can then be used for analytics as inputs into other models, such as e.g., a lifing model, a damage model, low cycle fatigue (LCF) models, high cycle fatigue (HCF) models, thermo-mechanical fatigue (TMF), creep, rupture, corrosion, Design Failure Mode and Effect Analysis (DFMEA) models, Computational Fluid Dynamics (CFD) models, engine cycle models, etc. And based on the outputs of these further models and/analytics, design improvements and changes can be made as necessary to the target turbine engine much earlier in the design process, among other benefits.

In some exemplary embodiments, the reference neural network is chosen to approximate the steady-state performance of the target turbine engine based at least in part by selecting a reference neural network that approximates the steady-state performance of a reference engine that is within or about within a similar thrust class as the target turbine engine. In this way, the reference neural network will best approximate the steady-state performance of the target engine. Where the two engines are in the same or similar thrust class, the two engines are more likely to have the same or similar operational characteristics, airframes, usages, etc. In one example, the maximum thrust of the target turbine engine is within about 20,000 lb_{f} of the maximum thrust of the reference turbine engine. In other embodiments, for example, the maximum thrust of the target turbine engine is within about 5,000 lb_{f} of the maximum thrust of the reference turbine engine.

In some exemplary embodiments, the reference neural network can be trained or retrained as a target neural network. To train the reference neural network into a target neural network, one or more supervised training techniques can be used as described above. Particularly, as data from the target turbine engine becomes available, this data can be used to train or retrain the reference neural network into a target neural network.

The systems and methods described herein may provide a number of technical effects and benefits and also provide an improvement to vehicle and aircraft computing technology. In one aspect, the machine-learned model of the computing system(s) of the present disclosure may provide for shorter processing times and may require less processing power than one or more computing systems executing a physics-based, steady-state cycle deck. Cycle decks can be computationally intensive and may require significant processing power to run. By modeling the cycle deck, the machine-learned models can output accurate approximations of engine performance without need to process significant lines of physics-inspired code, which generally require significant processing power to run. Consequently, processing times may be significantly reduced and the processing resources may be used for other core processing functions, among other benefits.

Additionally, the machine-learned model of the computing system or systems of the present disclosure may provide for fixed or known processor run times. With use of one of the machine-learned models of the present disclosure, for a given set of inputs, there is one or more outputs that are functions of adds, multiplies, and function calls. That is, the machine-learned model may have a fixed number of processor operations per time point. In contrast, cycle decks typically require the deck to converge (i.e., the thermodynamic cycle of the engine must be closed), leading to long and variable processor runtimes. A machine-learned model of the present disclosure, such as e.g., a neural network, relaxes the thermodynamic closure requirement and may be entirely state-based. Thus, as mentioned above, processing times may be fixed run times.

In another respect, cycle decks may also receive various outlier inputs, and as a result, the cycle deck may become trapped in a loop. In contrast, the machine-learned model of the present disclosure can be generally more robust and can generate reasonable outputs even given outlier inputs. Due to the architecture of the constructed machine-learning model, the model may not become trapped in a loop.

In yet another respect, a machine-learned model, such as a neural network, can be agnostic to the number of inputs received or obtained by the model. A traditional cycle deck uses a very small number of inputs (altitude, Mach, ambient temperature, fan speed); however, a neural network can be extended to include any number of additional inputs by e.g., adding neurons to the input layer of the network. As the number of turbine engine sensors increase, the sensed data can be included as inputs to updated models, facilitating even more accurate predictions of steady-state engine performance. In this way, machine-learned models can be flexible.

Moreover, machine-learned models can be flexible in that they can be easily ported between programming languages and are generally language/operating system agnostic, unlike cycle decks, which generally require special applications or software. This allows for the free data exchange of engine performance data between engine manufacturers and aircraft manufacturers or airframers.

The disclosed systems and methods also provide a technical effect and benefit of an improved process and method for modeling performance of a turbine engine before it has entered into service (i.e., before the engine has become fielded). Instead of creating, developing, and implementing a new physics-based model for each new engine or tweaking the physics-inspired algorithms, a machine-learned model can be employed for rapid predictions as to how the virtual or target turbine engine will perform under certain operating conditions, such as e.g., steady-state flight conditions in which the aircraft is in equilibrium or a non-accelerated state. Such machine-learned models can produce rapid results on an order of magnitude faster than physics-based cycle decks. The outputs of the machine-learned model can provide an opportunity for engineers and engine designers to optimize their engine designs early in the design phase, leading to more efficient use of resources.

Further aspects and advantages of the present subject matter will be apparent to those of skill in the art. Exemplary aspects of the present disclosure will be discussed in further detail with reference to the drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. The terms “upstream” and “downstream” refer to the relative flow direction with respect to fluid flow in a fluid pathway. For example, “upstream” refers to the flow direction from which the fluid flows, and “downstream” refers to the flow direction to which the fluid flows. “HP” denotes high pressure and “LP” denotes low pressure. Further, as used herein, the terms “axial” or “axially” refer to a dimension along a longitudinal axis of an engine. The term “forward” used in conjunction with “axial” or “axially” refers to a direction toward the engine inlet, or a component being relatively closer to the engine inlet as compared to another component. The term “rear” used in conjunction with “axial” or “axially” refers to a direction toward the engine nozzle, or a component being relatively closer to the engine nozzle as compared to another component. The terms “radial” or “radially” refer to a dimension extending between a center longitudinal axis (or centerline) of the engine and an outer engine circumference. Radially inward is toward the longitudinal axis and radially outward is away from the longitudinal axis.

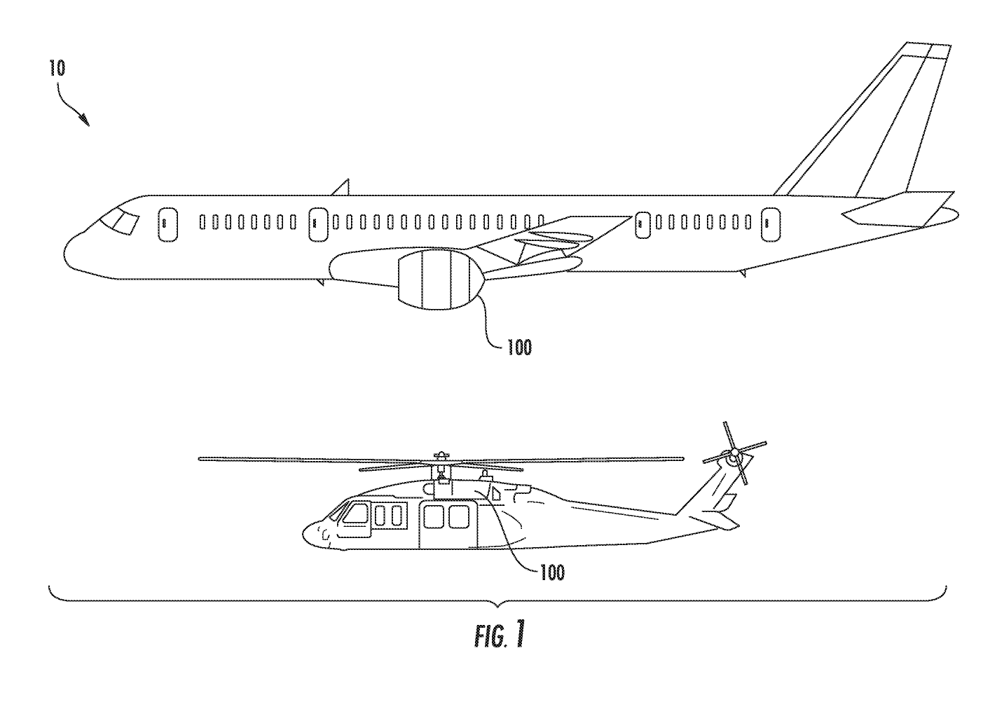

Turning now to the drawings, FIG. 1 provides exemplary vehicles 10 according to exemplary embodiments of the present disclosure. The systems and methods of the present disclosure can be implemented on an aircraft, such as e.g., a fixed-wing aircraft or a rotorcraft as shown, or on other vehicles such as boats, submarines, trains, tanks, and/or any other suitable vehicles that include one or more turbine engines(s) 100. While the present disclosure is described herein with reference to an aircraft implementation, this is intended only to serve as an example and not to be limiting. For instance, aspects of the present disclosure may be utilized with other types of turbine engines, such as power generation gas turbine engines or aeroderivative gas turbine engines.

During operation of the turbine engine(s) 100, the turbine engines 100 may be operated under steady-state conditions. Steady-state conditions are those in which the sum of the moments of all of the forces acting on the body (e.g., an aircraft) is equal to zero. In flight aerodynamics, steady-state conditions are achieved when all opposing forces acting on an aircraft are balanced. That is, lift equals weight and thrust equals drag (i.e., steady, unaccelerated flight conditions). Steady-state conditions may exist during various phases of a flight envelope, such as e.g., during constant rate climbs, during cruise phase, and during constant rate descents. Transient conditions, conversely, occur where the moments acting on the body are not equal. In flight aerodynamics, for example, in transient conditions, lift does not equal weight and/or thrust does not equal drag. The present disclosure primarily concerns steady-state conditions, although in some exemplary implementations the machine-learned models of the various computing systems described herein can be constructed to model transient conditions as well.

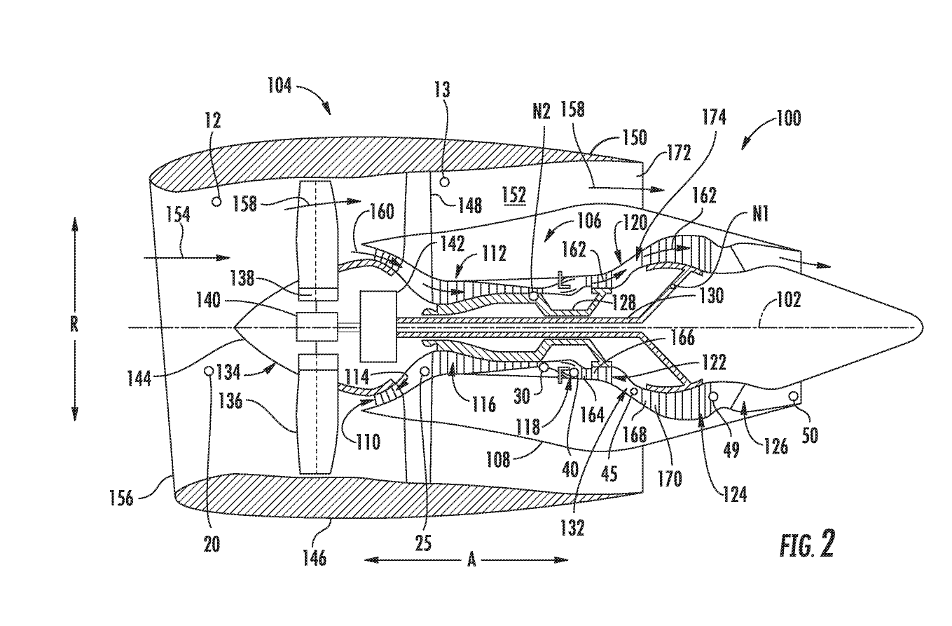

FIG. 2 provides a schematic cross-sectional view of exemplary turbine engine 100 according to exemplary embodiments of the present disclosure. For the embodiment of FIG. 2, the turbine engine 100 is an aeronautical, high-bypass turbofan jet engine configured to be mounted to or integral with a vehicle 10 (FIG. 1). The gas turbine engine 100 defines an axial direction A (extending parallel to or coaxial with a longitudinal centerline 102 provided for reference), a radial direction R, and a circumferential direction C (i.e., a direction extending about the axial direction A; not depicted). The gas turbine engine 100 includes a fan section 104 and a core turbine engine 106 disposed downstream from the fan section 104.

The exemplary core turbine engine 106 depicted generally includes a substantially tubular outer casing 108 that defines an annular inlet 110. The outer casing 108 encases, in serial flow relationship, a compressor section 112 including a first, booster or LP compressor 114 and a second, HP compressor 116; a combustion section 118; a turbine section 120 including a first, HP turbine 122 and a second, LP turbine 124; and a jet exhaust nozzle section 126. An HP shaft or spool 128 drivingly connects the HP turbine 122 to the HP compressor 116. ALP shaft or spool 130 drivingly connects the LP turbine 124 to the LP compressor 114. The compressor section 112, combustion section 118, turbine section 120, and jet exhaust nozzle section 126 together define a core air flowpath 132 through the core turbine engine 106.

The fan section 104 includes a fan 134 having a plurality of fan blades 136 coupled to a disk 138 in a circumferentially spaced apart manner. As depicted, the fan blades 136 extend outwardly from disk 138 generally along the radial direction R. The fan blades 136 and disk 138 are together rotatable about the longitudinal centerline 102 by the LP shaft 130 across a power gear box 142. The power gear box 142 includes a plurality of gears for stepping down the rotational speed of the LP shaft 130 for a more efficient rotational fan speed.

Referring still to the exemplary embodiment of FIG. 2, the disk 138 is covered by rotatable spinner 144 aerodynamically contoured to promote an airflow through the plurality of fan blades 136. Additionally, the exemplary fan section 104 includes an annular fan casing or outer nacelle 146 that circumferentially surrounds the fan 134 and/or at least a portion of the core turbine engine 106. Moreover, the nacelle 146 is supported relative to the core turbine engine 106 by a plurality of circumferentially spaced outlet guide vanes 148. Further, a downstream section 150 of the nacelle 146 extends over an outer portion of the core turbine engine 106 so as to define a bypass airflow passage 152 therebetween.

During operation of the gas turbine engine 100, a volume of air 154 enters the gas turbine engine 100 through an associated inlet 156 of the nacelle 146 and/or fan section 104. As the volume of air 154 passes across the fan blades 136, a first portion of the air 154 as indicated by arrows 158 is directed or routed into the bypass airflow passage 152 and a second portion of the air 154 as indicated by arrow 160 is directed or routed into the LP compressor 114 of the core turbine engine 106. The pressure of the second portion of air 160 is then increased as it is routed through the HP compressor 116 and into the combustion section 118.

The compressed second portion of air 160 discharged from the compressor section 112 mixes with fuel and is burned within the combustion section 118 to provide combustion gases 162. The combustion gases 162 are routed from the combustion section 118 along the hot gas path 174, through the HP turbine 122 where a portion of thermal and/or kinetic energy from the combustion gases 162 is extracted via sequential stages of HP turbine stator vanes 164 that are coupled to the outer casing 108 and HP turbine rotor blades 166 that are coupled to the HP shaft or spool 128, thus causing the HP shaft or spool 128 to rotate, thereby supporting operation of the HP compressor 116. The combustion gases 162 are then routed through the LP turbine 124 where a second portion of thermal and kinetic energy is extracted from the combustion gases 162 via sequential stages of LP turbine stator vanes 168 that are coupled to the outer casing 108 and LP turbine rotor blades 170 that are coupled to the LP shaft or spool 130, thus causing the LP shaft or spool 130 to rotate, thereby supporting operation of the LP compressor 114 and/or rotation of the fan 134.

The combustion gases 162 are subsequently routed through the jet exhaust nozzle section 126 of the core turbine engine 106 to provide propulsive thrust. Simultaneously, the pressure of the first portion of air 158 is substantially increased as the first portion of air 158 is routed through the bypass airflow passage 152 before it is exhausted from a fan nozzle exhaust section 172 of the gas turbine engine 100, also providing propulsive thrust. The HP turbine 122, the LP turbine 124, and the jet exhaust nozzle section 126 at least partially define a hot gas path 174 for routing the combustion gases 162 through the core turbine engine 106.

With reference still to FIG. 2, it will be appreciated that turbine engine 100 may be described with reference to certain stations, which may be stations set forth in SAE standard AS 755-D, for example. As shown, the stations may include a fan inlet primary airflow 20, a fan inlet secondary airflow 12, a fan outlet guide vane exit 13, a HP compressor inlet 25, a HP compressor discharge 30, a HP turbine inlet 40, a LP turbine inlet 45, a LP turbine discharge 49, and a turbine frame exit 50. Each station may have certain temperatures T, pressures P, mass flow rates W, fuel flows Wf, etc. associated with the particular station of the turbine engine 100. For example, a portion of air 154 at the LP turbine inlet 45 may have a certain temperature denoted as T45, a pressure denoted as P45, and a mass flow denoted as W45. As further shown, the fan speed N1 is representative of the rotational speed of the LP shaft or spool 130 and the core speed N2 is representative of the rotation speed of the HP shaft or spool 128.

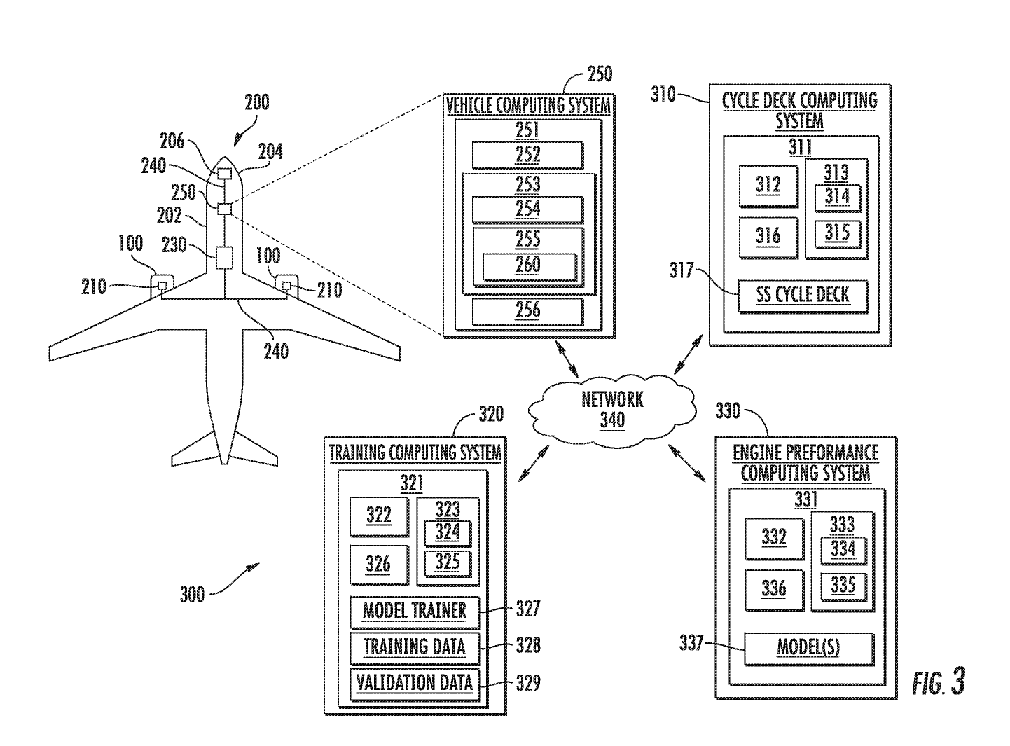

FIG. 3 provides a schematic view of an exemplary aircraft 200 and computing system 300 according to exemplary embodiments of the present disclosure. The computing system 300 illustrated in FIG. 3 is provided by way of example only. The components, systems, connections, and/or other aspects illustrated in FIG. 3 are optional and are provided as examples of what is possible, but not required, to implement the present disclosure. As shown, the exemplary computing system 300 can include a vehicle computing system 250 located onboard exemplary aircraft 200, a cycle deck computing system 310, a training computing system 320 and an engine performance computing system 330 that are communicatively coupled over a network 340. In some implementations, the engine performance computing system 330 can be included in the vehicle computing system 250 or otherwise physically located onboard the aircraft 200.

The aircraft 200 includes one or more engine(s) 100, a fuselage 202, a cockpit 204, a display 206 for displaying information to the flight crew, and one or more engine controller(s) 210 configured to control the one or more engine(s) 100. For example, as depicted in FIG. 3, the aircraft 200 includes two engines 100 that are controlled by their respective controllers 210. For this embodiment, the aircraft 200 includes one engine 100 mounted to or integral with each wing of the aircraft 200. Each engine controller 210 can include, for example, an Electronic Engine Controller (EEC) or an Electronic Control Unit (ECU) of a Full Authority Digital Engine Control (FADEC). Each engine controller 210 includes various components for performing various operations and functions, such as e.g., for collecting and storing flight data from one or more engine or aircraft sensors.

Although not shown, each engine controller 210 can include one or more processor(s) and one or more memory device(s). The one or more processor(s) can include any suitable processing device, such as a microprocessor, microcontroller, integrated circuit, logic device, and/or other suitable processing device. The one or more memory device(s) can include one or more computer-readable media, including, but not limited to, non-transitory computer-readable media, RAM, ROM, hard drives, flash drives, and/or other memory devices.

The one or more memory device(s) can store information accessible by the one or more processor(s), including computer-readable instructions that can be executed by the one or more processor(s). The instructions can be any set of instructions that when executed by the one or more processor(s) cause the one or more processor(s) to perform operations. The instructions can be software written in any suitable programming language or can be implemented in hardware. Additionally, and/or alternatively, the instructions can be executed in logically and/or virtually separate threads on processor(s).

The memory device(s) can further store data that can be accessed by the one or more processor(s). For example, the data can include flight data collected from various engine sensors. The flight data can contain past flight history for various flight missions, for example. Specifically, the past flight data can include operating parameters indicative of the operating conditions of the turbine engines 100 during operation. The data can also include other data sets, parameters, outputs, information, etc. shown and/or described herein.

The engine controller(s) 210 can also include a communication interface used to communicate, for example, with the other components of the aircraft 200 (e.g., via a communication network 230). The communication interface can include any suitable components for interfacing with one or more network(s), including for example, transmitters, receivers, ports, controllers, antennas, and/or other suitable components.

The engine controller(s) 210 are communicatively coupled with a communication network 230 of the aircraft 200. Communication network 230 can include, for example, a local area network (LAN), a wide area network (WAN), SATCOM network, VHF network, a HF network, a Wi-Fi network, a WiMAX network, a gatelink network, and/or any other suitable communications network for transmitting messages to and/or from the aircraft 200, such as to a cloud computing environment and/or the off board computing systems. Such networking environments may use a wide variety of communication protocols. The communication network 230 can include a data bus or a combination of wired and/or wireless communication links. The communication network 230 can also be coupled to the one or more controller(s) 210 by one or more communication cables 240 or by wireless means. The one or more controller(s) 210 can be configured to communicate with one or more computing devices 251 of a vehicle computing system 250 via the communication network 230.

As shown in FIG. 3, vehicle computing system 250 can include one or more computing device(s) 251. The computing device(s) 251 can include one or more processor(s) 252 and one or more memory device(s) 253. The one or more processor(s) 252 can include any suitable processing device, such as a microprocessor, microcontroller, integrated circuit, logic device, and/or other suitable processing device. The one or more memory device(s) 253 can include one or more computer-readable media, including, but not limited to, non-transitory computer-readable media, RAM, ROM, hard drives, flash drives, and/or other memory devices.

The one or more memory device(s) 253 can store information accessible by the one or more processor(s) 252, including computer-readable instructions 254 that can be executed by the one or more processor(s) 252. The instructions 254 can be any set of instructions that when executed by the one or more processor(s) 252, cause the one or more processor(s) 252 to perform operations. In some embodiments, the instructions 254 can be executed by the one or more processor(s) 252 to cause the one or more processor(s) 252 to perform operations, such as any of the operations and functions for which the computing device(s) 251 are configured. The instructions 254 can be software written in any suitable programming language or can be implemented in hardware. Additionally, and/or alternatively, the instructions 254 can be executed in logically and/or virtually separate threads on processor(s) 252.

The memory device(s) 253 can further store data 255 that can be accessed by the one or more processor(s) 252. For example, the data 255 can include flight data transmitted from the engine controller(s) 210 to the vehicle computing system 250 via one or more communication lines 240 over communication network 230. The flight data can be stored in a flight data library 260, for example, which can be downloaded or transmitted to other computing systems as further described herein.

The computing device(s) 251 can also include a communication interface 256 used to communicate, for example, with the other components of the aircraft 200 (e.g., via communication network 230). The communication interface 256 can include any suitable components for interfacing with one or more network(s), including for example, transmitters, receivers, ports, controllers, antennas, and/or other suitable components.

The cycle deck computing system 310 can include one or more computing device(s) 311. The computing device(s) 311 can include one or more processor(s) 312 and one or more memory device(s) 313. The one or more processor(s) 312 can include any suitable processing device, such as a microprocessor, microcontroller, integrated circuit, logic device, and/or other suitable processing device. The one or more memory device(s) 313 can include one or more computer-readable media, including, but not limited to, non-transitory computer-readable media, RAM, ROM, hard drives, flash drives, and/or other memory devices.

The one or more memory device(s) 313 can store information accessible by the one or more processor(s) 312, including computer-readable instructions 314 that can be executed by the one or more processor(s) 312. The instructions 314 can be any set of instructions that when executed by the one or more processor(s) 312, cause the one or more processor(s) 312 to perform operations. In some embodiments, the instructions 314 can be executed by the one or more processor(s) 312 to cause the one or more processor(s) 312 to perform operations, such as operations for processing flight data and outputting engine performance data. The instructions 314 can be software written in any suitable programming language or can be implemented in hardware. Additionally, and/or alternatively, the instructions 314 can be executed in logically and/or virtually separate threads on processor(s) 312.

The memory device(s) 313 can further store data 315 that can be accessed by the one or more processor(s) 312. The computing device(s) 311 can also include a communication interface 316 used to communicate, for example, with the other computing devices or systems over network 340. The communication interface 316 can include any suitable components for interfacing with one or more network(s), including for example, transmitters, receivers, ports, controllers, antennas, and/or other suitable components.

One or more computing device(s) 311 of the cycle deck computing system 310 can include a cycle deck model 317, such as a steady-state cycle deck. In some exemplary embodiments, the cycle deck model 317 is a computational, thermodynamic model for modeling the performance of a gas turbine engine of an aircraft. Further, in some implementations, the cycle deck 317 is physics-based model. One such physics-based cycle deck model could be a Numerical Propulsion System Simulation (NPSS®) model owned by Southwest Research Institute® of San Antonio, Tex.

In some implementations, a data set of flight data indicative of the operating conditions of a gas turbine engine of an aircraft during operation can be input into the cycle deck 137. The data can be processed by one or more processor(s) 312 of one or more computing device(s) 311 of the cycle deck computing system 310. After processing, one or more performance indicators indicative of the performance of the turbine engine during operation can be generated as an output of the cycle deck 137. The performance indicators, such as mass flows W, station temperatures T or pressures P, fuel flows Wf, etc. can then be used for analytics, further modeling of the engine, or the like. The flight data can be indicative of steady-state conditions of the turbine engine over one or more points of a flight envelope, for example.

The machine learning computing system, or this embodiment the engine performance computing system 330 can include one or more computing device(s) 331. Each of the computing device(s) 331 can include one or more processor(s) 332 and a memory 333. The one or more processors 332 can be any suitable processing device (e.g., a processor core, a microprocessor, an ASIC, a FPGA, a controller, a microcontroller, etc.) and can be one processor or a plurality of processors that are operatively connected. The memory 333 can include one or more memory devices, non-transitory computer-readable storage mediums, such as RAM, ROM, EEPROM, EPROM, flash memory devices, magnetic disks, etc., and combinations thereof. The memory 333 can store data 335 and instructions 334 that are executable by the processor(s) 332 to cause the engine performance computing system 330 to perform operations. The engine performance computing system 330 can also include a communication interface 336 that includes any suitable components for interfacing with one or more networks to communicate with another system (e.g., vehicle computing system 250, cycle deck computing system 310, training computing system 320, etc.).

The engine performance computing system 330 can store or otherwise include one or more machine-learned models 337. For example, the models 337 can be or can otherwise include various machine-learned models such as neural networks (e.g., deep recurrent neural networks) or other multi-layer non-linear models. In some exemplary embodiments, the machine-learned model 337 can be configured to approximate the steady-state performance of a turbine engine.

More particularly, in some implementations, the engine performance computing system 330 and/or other computing systems can train the model 337 via interaction with the training computing system 320 that is communicatively coupled over the network 340. The training computing system 320 can be separate from the engine performance computing system 330 or can be a portion of the engine performance computing system 330 in some embodiments.

The training computing system 320 includes one or more computing device(s) 321. Each of the computing device(s) 321 can include one or more processor(s) 322 and one or more memory device(s) 323. The one or more processor(s) 322 can be any suitable processing device (e.g., a processor core, a microprocessor, an ASIC, a FPGA, a controller, a microcontroller, etc.) and can be one processor or a plurality of processors that are operatively connected. The memory 323 can include one or more memory devices, non-transitory computer-readable storage mediums, such as RAM, ROM, EEPROM, EPROM, flash memory devices, magnetic disks, etc., and combinations thereof. The memory 323 can store data 325 and instructions 324 that are executed by the processor 322 to cause the processors 322 of the computing device(s) 321 to perform operations. In some implementations, the training computing system 320 can include or is otherwise implemented by one or more engine performance computing devices 330. The training computing system 320 can also include a communication interface 326 that includes any suitable components for interfacing with one or more networks to communicate with another system.

The training computing system 320 can include a model trainer 327 that trains the models 337 using various training or learning techniques, such as, for example, backwards propagation of errors. In some implementations, supervised training techniques can be used on a set of labeled training data. In some implementations, performing backwards propagation of errors can include performing truncated backpropagation through time. The model trainer 327 can perform a number of generalization techniques (e.g., weight decays, dropouts, etc.) to improve the generalization capability of the models 337 being trained.

The model trainer 327 can train a model 337 based on a set of training data 328. The training data 328 can include, for example, a number of cycle deck inputs and corresponding cycle deck outputs. In some implementations, cycle deck inputs used to create training data 328 can be taken strictly from one gas turbine engine such that the engine performance of that particular engine can be assessed, as opposed to one or more engines of the aircraft or a fleet of engines. In this way, model 337 can be trained to determine or generate approximations of engine performance specific to that turbine engine.

The network 340 can be any type of communications network, such as a local area network (e.g., intranet), wide area network (e.g., Internet), or some combination thereof and can include any number of wired or wireless links. In general, communication over the network 340 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 3 illustrates one example computing system 300 that can be used to implement the present disclosure. Other computing systems can be used as well. For example, in some implementations, the vehicle computing system 250 can include the model trainer 327 and the training data 328. In such implementations, the models 337 can both be trained and used locally at the vehicle computing system 250. As another example, in some implementations, the vehicle computing system 250 is not connected to the other computing systems and may perform all operations onboard the aircraft 200.

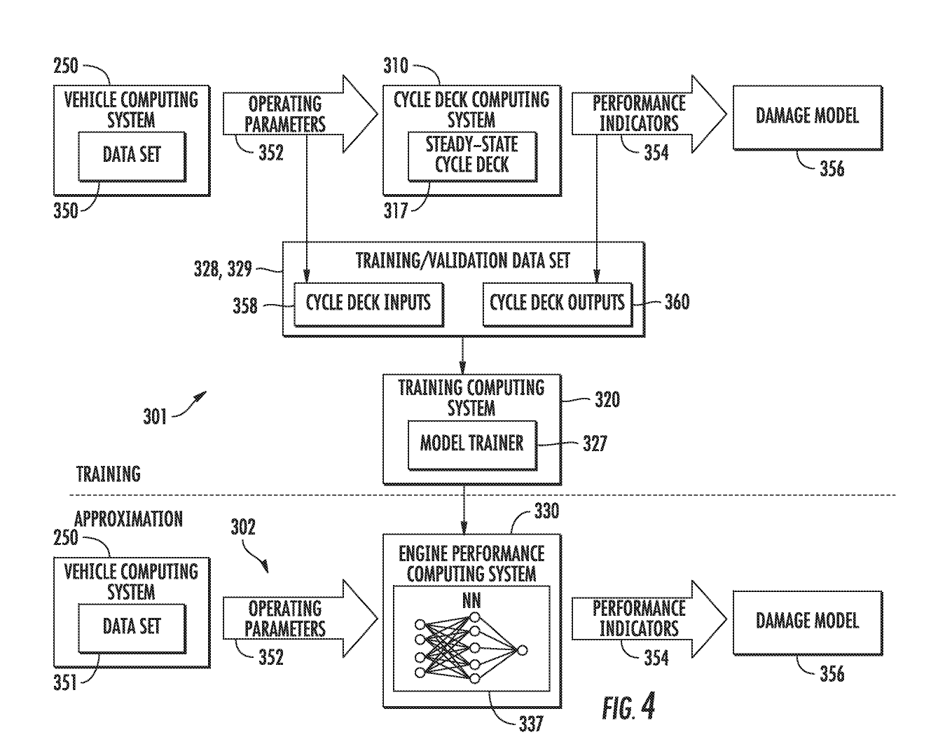

FIG. 4 provides a flow diagram of exemplary computing system 300 according to exemplary embodiments of the present disclosure. The computing system 300 is illustrated as including a training portion 301 and an approximation portion 302.

As shown, the training portion 301 includes a data set 350 configured to be input into the cycle deck computing system 310. The data set 350 includes one or more operating parameters 352 indicative of the operating conditions of the turbine engine during operation. By way of example, the one or more operating parameter(s) 352 can include a fan speed, an altitude, a Mach number, an ambient temperature, etc. These various operating parameters 352 can be obtained, acquired, or otherwise received from a set of data collection devices, such as a set of engine sensors, for example.

The data set 350 can be stored on one or more memory devices of one of the computing devices of computing system 300. For example, the data set 350 can be stored in the flight data library 260 of the memory device 253 of one of the computing device(s) 251 of the vehicle computing system 250. The data set 350 can be transmitted to or otherwise obtained by the cycle deck computing system 310 via network 340, for example. It will be appreciated that the data set 350 may be pre-processed before being input into the cycle deck 317.

At least a portion of the data set is input into the cycle deck 317. The data is processed by one or more processor(s) 312 of one of the computing device(s) 311 of the cycle deck computing system 310. One or more performance indicators 354 can be generated as an output or outputs of the cycle deck 317. The performance indicators 354 can be, for example, a core speed, a mass flow, one or more station temperatures or pressures, or any other performance indicator that cannot be or cannot be easily calculated with current technology, such as various clearances and stall margins. The generated or outputted performance indicators 354 can then be used for data analytics or as inputs for other models, such as e.g., a damage model, a deterioration model, and/or a lifing model. In the example illustrated in FIG. 4, the performance indicators 354 are input into a damage model 356.

As mentioned previously, while physics-based cycle decks 317 can generally generate accurate representations of steady-state engine performance, they can be challenging to deploy.

As further shown in FIG. 4, the inputs, or in this example the operating parameters 352, and the outputs, or in this example the performance indicators 354, can be used as training data 328 and/or validation data 329 to train and/or validate the model 337. In particular, the operating parameters 352 of the data set 350 can be used as cycle deck inputs 358 for training and validating the model 337. The performance indicators 354 generated as outputs of the cycle deck 317 can be used as expected or target values for one or more cycle deck inputs 358 input into the model 337 or model trainer 327, denoted herein as cycle deck outputs 360. In this way, for training the model 337, for example, the cycle deck inputs 358 can be input into the model or model trainer 327 and an output will be generated. The output of the model can then be compared to the cycle deck output 360 such that an error delta can be calculated. Then, using any suitable training or statistical technique, such as a feed forward-back propagation technique where the model is a neural network, the weights of the model 337 can be adjusted such that the output of the model can match the cycle deck output 360 within a particular error margin, such as +/−1%. The training process may iterate until such a satisfactory error margin is achieved. In this way, the machine-learned model can be constructed within arbitrarily good precision to the training data set.

At least a portion of the cycle deck inputs 358 and their corresponding cycle deck outputs 360 can be partitioned into a validation data set 329. The validation data set 329 can be fed through the model 337 and/or model trainer 327 to validate that the model 337 will behave accurately even when presented with novel input data. In this way, the accuracy of the model 337 can be verified. When training is complete and the model 337 is validated, the model 337 is configured to be a model of the cycle deck 317; and accordingly, the model is configured to approximate the engine performance of one or more turbine engines.

The training 301 can be temporary or on-going. For example, the training 301 may only occur during setup or installation of the computing system 300. Additionally or alternatively, the training 301 may continue during standard operation (e.g., during approximation 302) of the computing system 300 to improve approximation of engine performance of one or more gas turbine engines.

The approximation portion 102 includes a data set 351. The data set 351 may be a novel data set that has not yet been fed through the model 337, for example. Similar to the data set 350 used in the training portion 301, the new data set 351 can be received from the same or an expanded set of data collection devices, such as engine sensors. Moreover, like the data set 350, the new data set 351 can include a number of operating parameters 352 that are indicative of one or more operating conditions of the turbine engine during operation.

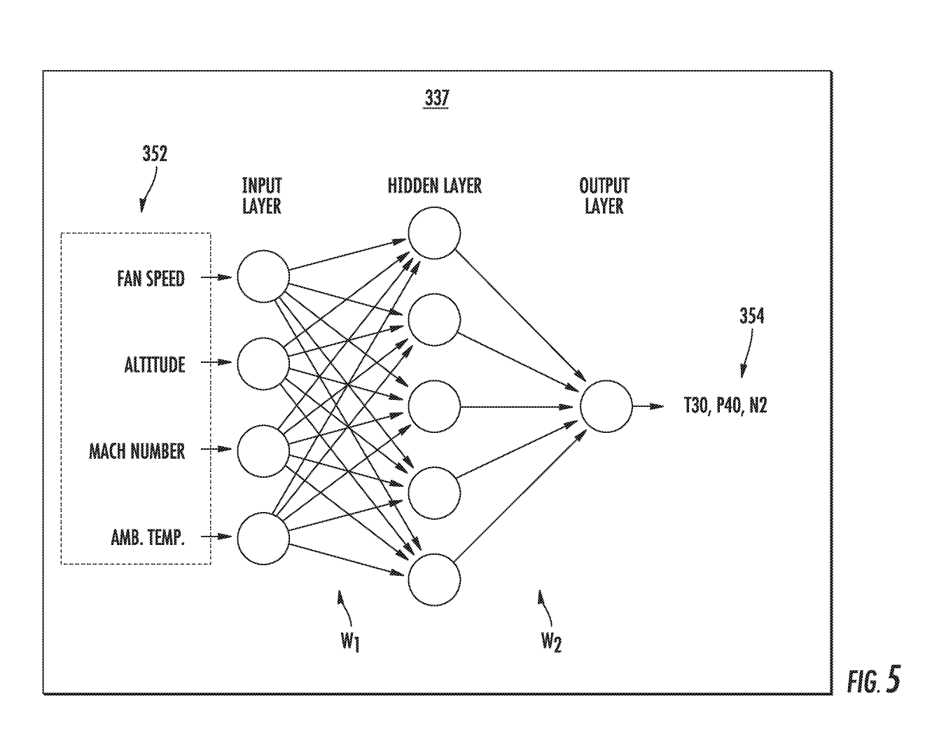

One or more of the computing devices 331 of the engine performance computing system 330 receives or otherwise obtains the data set 351, and at least a portion of the new data set 351 is input into the model 337. In some exemplary embodiments, the machine-learned model 337 is a neural network. One such neural network is shown in more detail in FIG. 5.

FIG. 5 provides an exemplary neural network trained to output approximations of the steady-state engine performance of a turbine engine according to exemplary embodiments of the present disclosure. For this embodiment, the neural network includes an input layer, a hidden layer, and an output layer. Although only one hidden layer is shown, it will be appreciated that more than one hidden layer can be included in the neural network. The input layer includes four neurons, the hidden layer includes five neurons, and the output layer includes one neuron. It will be appreciated that any suitable number of neurons may be included in each layer and that the example of FIG. 5 is for exemplary purposes and should not be construed to be limiting in any way. Between the neurons of the input and the hidden layer and between the hidden and output layers, various synapses are shown extended therebetween. Each synapsis has a particular weight associated with it, as will be appreciated by one of skill in the art.

As shown, the data set 351 that includes one or more operating parameters 352 is input into the network. Specifically, a fan speed, a Mach number, an altitude, and an ambient temperature of the turbine engine over one or more points of a flight envelope are input into their respective neurons of the input layer of the neural network. As the inputs are fed forward through the network, a set of first weights w₁, each of which may be different for each synaptic connection, are applied to the input values. Then each neuron of the hidden layer adds the outputs from its corresponding synapses between the input layer and the hidden layer and applies an activation function. Thereafter, the values from the activation function are fed forward toward the output layer where a set of second weights w₂, each of which may be different for each synaptic connection, is applied to the outputs of the activation functions of the hidden layer. The neuron of the output layer receives the values from the synaptic connections and likewise applies an activation function to render an output of the network. In this example, the output of the network is one or more performance indicators 354 of the turbine engine. By way of example, as shown, the performance indicators can be a HP compressor discharge temperature T30, a HP turbine inlet pressure P40, or a core speed N2. Other suitable performance indicators are contemplated.

The engine performance computing system 330 can receive the one or more performance indicators 354 of the turbine engine. As the model 337 is trained based at least in part on the cycle deck 317, the performance indicators 354 approximate the performance of a turbine engine. Where the cycle deck 317 used for training is a steady-state cycle deck, the performance indicators 354 approximate the steady-state performance of a turbine engine.

Returning now to FIG. 4, the performance indicators 354 can be transmitted to or otherwise obtained by a damage model 356. It will be appreciated that the generated or outputted performance indicators 354 can also be used for data analytics or as inputs for other types of models, such as e.g., a deterioration model, and/or a lifing model.

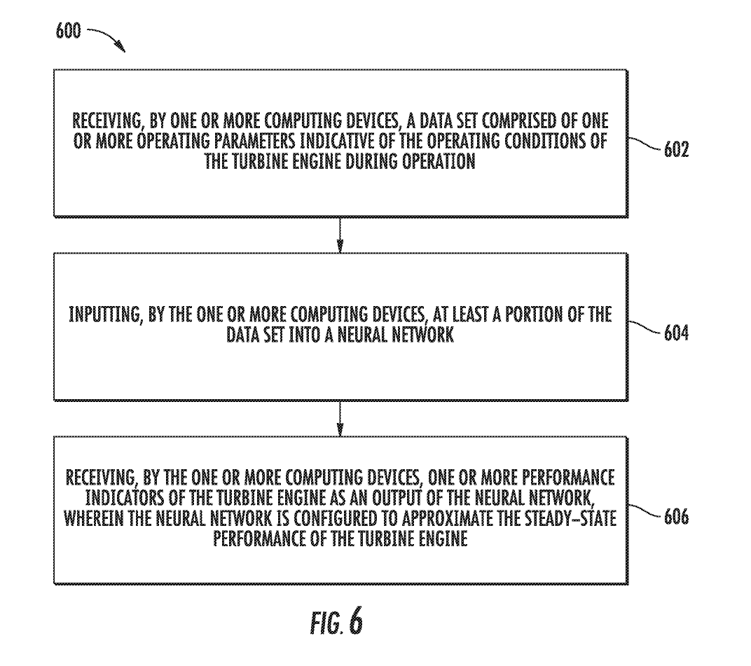

FIG. 6 provides a flow diagram of an exemplary method (600) for steady-state performance approximation of a turbine engine according to exemplary embodiments of the present disclosure. Some or all of the method (600) can be implemented by one of the computing device(s) 331 of engine performance computing system 330 described herein or any other computing devices of computing system 300. Some or all of the method (600) can be performed onboard the aircraft 200 and while the aircraft 200 is in operation, such as when an aircraft 200 is in flight. Additionally or alternatively, some or all of the method (600) can be performed while the aircraft 200 is not in operation and/or off board of the aircraft 200. Moreover, FIG. 6 depicts method (600) in a particular order for purposes of illustration and discussion. It will be appreciated that exemplary method (600) can be modified, adapted, expanded, rearranged and/or omitted in various ways without deviating from the scope of the present subject matter.

At (602), exemplary method (600) includes receiving, by one or more computing devices, a data set 351 that includes one or more operating parameters 352 indicative of the operating conditions of the turbine engine 100 during operation.

In some implementations, the one or more operating parameters 352 of the data set 352 may include at least one of: a fan speed, an altitude, an ambient temperature, and an aircraft Mach number, for example. Where turbine engine 100 is mounted to or integral with a rotorcraft, exemplary operating parameters 352 may include a forward air speed, a requested torque, and/or a requested power. For military applications, core speed N2 may also be an operating parameters, as the fan speed N1 and core speed N2 may not be in a linear relationship due to increased throttle movement.

At (604), exemplary method (600) includes inputting, by the one or more computing devices, at least a portion of the data set 351 into a neural network 337. In some exemplary implementations, the neural network is trained based at least in part by a steady-state cycle deck. The steady-state cycle deck can be a physics-based model configured to model engine performance.

At (606), exemplary method (600) includes receiving, by the one or more computing devices, one or more performance indicators 354 of the turbine engine 100 as an output of the neural network 337, wherein the neural network 337 is configured to approximate the steady-state performance of the turbine engine 100. In some implementations, the performance indicators 354 include at least one of: a mass flow, one or more station temperatures or pressures, and a core speed. The performance indicators 354, which approximate the engine performance of the turbine engine 100, can then be provided by the one or more computing devices to a damage model 356 or the like.

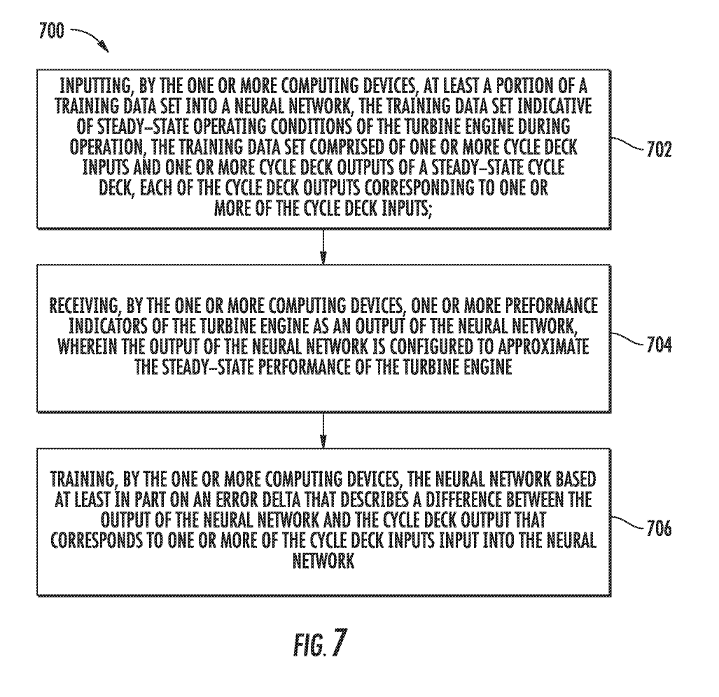

FIG. 7 provides a flow diagram of an exemplary method (700) for training a neural network configured to approximate the steady-state performance of a turbine engine according to exemplary embodiments of the present disclosure. Some or all of the method (700) can be implemented by one or more computing devices of the computing system 330 described herein. Some or all of the method (700) can be performed onboard the aircraft 200 and while the aircraft 200 is in operation, such as when an aircraft 200 is in flight. Alternatively, some or all of the method (700) can be performed while the aircraft 200 is not in operation and/or off board of the aircraft 200. In addition, FIG. 7 depicts method (700) in a particular order for purposes of illustration and discussion. It will be appreciated that exemplary method (700) can be modified, adapted, expanded, rearranged and/or omitted in various ways without deviating from the scope of the present subject matter.

At (702), exemplary method (700) includes inputting, by the one or more computing devices, at least a portion of a training data set 328 into a neural network 337, the training data set 328 indicative of steady-state operating conditions of the turbine engine 100 during operation, the training data set 328 includes one or more cycle deck inputs 358 and one or more cycle deck outputs 360 of a steady-state cycle deck 317, each of the cycle deck outputs 360 corresponding to one or more of the cycle deck inputs 358.

At (704), exemplary method (700) includes receiving, by the one or more computing devices, one or more performance indicators 354 of the turbine engine 100 as an output of the neural network 337, wherein the output of the neural network 337 is configured to approximate the steady-state performance of the turbine engine 100.

At (706), exemplary method (700) includes training, by the one or more computing devices, the neural network 337 based at least in part on an error delta that describes a difference between the output (i.e., performance indicator(s) 354) of the neural network 337 and the cycle deck output 360 that corresponds to one or more of the cycle deck inputs 358 input into the neural network 337.

In some implementations, after training, the method (700) is repeated at least until the error delta that describes a difference between the output of the neural network 337 and the cycle deck output 360 that corresponds to one or more of the cycle deck inputs 358 is about within a threshold percentage, such as e.g., plus or minus one (1) percent. In yet other exemplary implementations, the method (700) is repeated at least until the error delta that describes a difference between the output of the neural network 337 and the cycle deck output 360 that corresponds to one or more of the cycle deck inputs 358 is about within plus or minus two (2) percent, about within plus or minus three (3) percent, about within plus or minus four (4) percent, or about within plus or minus five (5) percent.

In some exemplary implementations, the model 337 (i.e., the neural network) may be validated. Specifically, after training, the method further includes receiving, by one or more computing devices, a validation data set 329 indicative of steady-state operating conditions of the turbine engine 100 during operation, the validation data set includes one or more cycle deck inputs 358 and one or more cycle deck outputs 360 of the steady-state cycle deck 317, each of the cycle deck outputs 360 corresponding to one or more of the cycle deck inputs 358. After receiving, the method (700) may further include inputting, by the one or more computing devices, at least a portion of the cycle deck inputs 358 of the validation data set 329 into the neural network 337. Thereafter, the method (700) includes receiving, by the one or more computing devices, one or more performance indicators 354 of the turbine engine 100 as an output of the neural network 337. Once the performance indicators 354 are received, the method (700) also includes determining, by the one or more computing devices, an error delta that describes a difference between the output of the neural network 337 and the cycle deck output 360 that corresponds to one or more of the cycle deck inputs 358 of the validation data set 329 input into the neural network 337. And finally, the method (700) may also include determining, by the one or more computing devices, whether the error delta that describes a difference between the output of the neural network 337 and the cycle deck output 360 that corresponds to one or more of the cycle deck inputs 358 is about within plus or minus one (1) percent. If the error delta is within plus or minus one (1) percent, then in some embodiments, the model 337 is deemed validated.

In yet other exemplary implementations, the machine-learned model 337 is a neural network. The neural network includes an input layer, a hidden layer, which may include one or more hidden layer nodes, and an output layer. And if the error delta is not about within plus or minus one (1) percent, the method (700) further includes adjusting, by one or more computing devices, the number of hidden layer nodes.

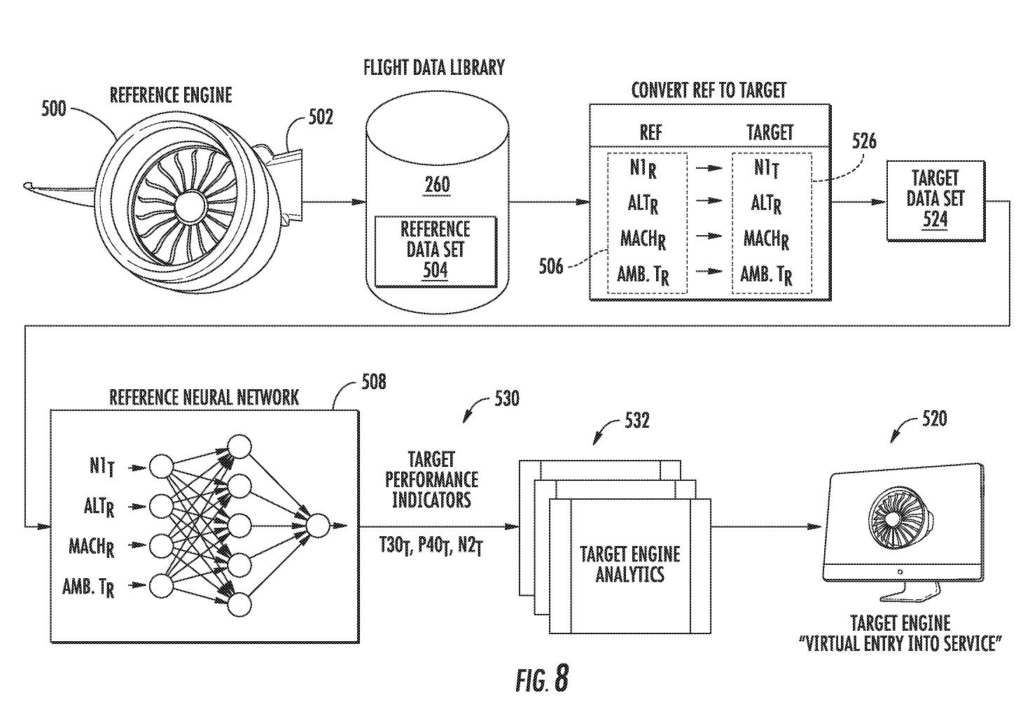

In another exemplary aspect of the present disclosure, systems and methods that include and/or leverage a neural network, or more broadly, a machine-learned model to approximate the steady-state performance of a “virtual” or target turbine engine are provided. The neural network may provide a “virtual entry into service” for non-fielded turbine engines. FIG. 8 provides a flow diagram for approximating the steady-state performance of a target turbine engine based at least in part on a reference neural network configured to approximate the steady-state performance of a reference turbine engine according to exemplary embodiments of the present disclosure.

As shown in FIG. 8, a reference turbine engine 500 is mounted to or integral with a wing of a reference aircraft 502. Although not shown, the reference turbine engine 500 includes one or more sensors and one or more engine controllers for collecting data from the sensors of the reference turbine engine 500. The data collected from the sensors may be representative of one or more operating parameters of the reference turbine engine 500 at a particular point over the flight envelope, such as e.g., fan speed N1, altitude, Mach number, and ambient temperature. The engine controller can store the flight data in one or more of its memory devices or the data can be transmitted to or otherwise obtained by a computing device of the reference aircraft 502. The computing device may store the flight data in a flight data library 260, for example, such that the data can be downloaded, transmitted, or otherwise obtained by an onboard or off board computing system.

The reference turbine engine 500 can be within a particular thrust class, such as e.g., 20,000-35,000 lb_{f}, 18,000-24,000 lb_{f}, etc. Moreover, it will be appreciated that the airframe of the reference aircraft 502 can have unique structural geometries and characteristics. For instance, the airframe of the reference aircraft 502 can have a certain size, shape, and weight and may be arranged in a certain way. The airframe of the reference aircraft 502 may be made of certain materials and may be aerodynamically contoured in a particular way. Additionally, the airframe of the reference aircraft 502 may have a certain fuel capacity, range, and torsional characteristics, as well as stress capabilities, among other airframe characteristics. Furthermore, the airframe of the reference aircraft 502 may have a particular usage. Flight usage can be tracked on an individual aircraft basis using sensed, measured, or predicted flight data. The flight data can include data from strain and/or stress sensors or can be derived therefrom. The flight data can be used to classify the reference aircraft 502 has having a particular usage. By way of example, commercial aircraft could be classified into cargo-carrying, passenger-carrying, etc.

In selecting the reference neural network 508 to approximate the steady-state performance of a particular target turbine engine, in some embodiments, the reference neural network 508 is selected at least in part by comparing the airframe of target aircraft 522 (or its proposed design) in which the target turbine engine 520 is to be mounted to or integral with to the airframe of the reference aircraft 502. If the airframe of the reference aircraft 502 is the same or similar to the airframe (or proposed airframe) of the target aircraft 522, then the reference neural network 508 is selected for use to approximate the engine performance of the target turbine engine 520.

In some exemplary implementations, in selecting the reference neural network 508 to approximate the steady-state performance of a particular target turbine engine, the reference neural network 508 is selected at least in part by comparing the thrust class (e.g., 18,000-24,000 lb_{f}) of the target turbine engine 520 (or its proposed thrust class) to the thrust class of the reference turbine engine 500. If the thrust class of the reference turbine engine 500 is the same or similar to the target turbine engine 520 (or proposed thrust class), then the reference neural network 508 is selected for use to approximate the engine performance of the target turbine engine 520.

In yet other implementations, in selecting the reference neural network 508 to approximate the steady-state performance of a particular target turbine engine, the reference neural network 508 is selected at least in part by comparing the maximum thrust of the target turbine engine 520 (or its proposed maximum thrust) to the maximum thrust of the reference turbine engine 500. For example, in some embodiments, where the maximum thrust of the target turbine engine 520 (or its designed maximum thrust) is within about 20,000 lb_{f} of the maximum thrust of the reference turbine engine 500, the reference neural network 508 is selected to approximate the steady-state performance of the target turbine engine 520. In other examples, where the maximum thrust of the target turbine engine 520 (or its designed maximum thrust) is within about 15,000 lb_{f}, within about 10,000 lb_{f}, or within about 5,000 lb_{f} of the maximum thrust of the reference turbine engine 500, the reference neural network 508 is selected to approximate the steady-state performance of the target turbine engine 520. In this way, the reference neural network 508 may more accurately model the engine performance of the target turbine engine 520.

In yet other exemplary implementations, in selecting the reference neural network 508 to approximate the steady-state performance of a particular target turbine engine, the reference neural network 508 is selected at least in part by comparing the proposed usage of the target aircraft 522 to the usage of the reference aircraft 502. If the usage of the reference aircraft 502 is the same or similar to the target aircraft's proposed usage, then the reference neural network 508 is selected for use to approximate the engine performance of the target turbine engine 520. For example, where the target aircraft 522 is designed as a passenger-carrying aircraft, a reference neural network 508 can be selected that approximates the engine performance of a reference turbine engine 500 mounted to or integral with a reference aircraft 502 configured as a passenger-carrying aircraft.

Referring still to FIG. 8, after the flight data is collected by the aircraft sensors, data collection devices, or other feedback devices, the flight data is stored in the flight data library 260, as noted above. The flight data library 260 stores a reference data set 504 that includes one or more reference operating parameters 506 indicative of the operational conditions of the reference turbine engine 500 during operation. In this example, the reference operating parameters 506 include a reference fan speed N1_{R}, a reference altitude Alt_{R}, a reference Mach number Mach_{R}, and a reference ambient temperature Amb. T_{R} over one or more points of a flight envelope.

As shown, the reference data set 504 is converted into a target data set 524. Specifically, one or more of the reference operating parameters 506 are converted into target operating parameters 526. The reference operating parameters can be converted to target operating parameters by utilizing the steady-state cycle deck used to train the reference neural network and one or more statistical or machine-learning techniques.

By way of example as shown in FIG. 8, the reference fan speed N1_{R} is converted to a target fan speed N1_{T}. First, a series of thrusts can be selected at certain intervals over the thrust range of the particular reference turbine engine 500. Then, utilizing the steady-state cycle deck used to train the reference neural network 508 can be used to calculate what the fan speed of the reference turbine engine 500 was at the various selected thrusts. Thus, the fan speeds at the selected thrusts are known for the reference turbine engine 500.

The fan speeds for the selected thrusts for the target turbine engine 520 are then determined. To do so, the engine specifications of the target turbine engine 520 are entered into the steady-state cycle deck. Specifically, the target engines fan specifications and relevant engine design characteristics can be input into the cycle deck. The cycle deck can be used to calculate what the fan speed of the target turbine engine 520 was to achieve the selected thrusts.

Then, once the fan speeds for the reference and target turbine engines 500, 520 are known for the selected thrusts, a regression analysis can be used to determine the fan speeds for thrusts at certain operating conditions over the entire flight envelope. In addition to a regression technique, other techniques such as one or more extrapolation and/or interpolation techniques can be used alone or in combination with the regression technique to infer and or determine target operating parameters 526 based at a least in part on known relationships between reference operating parameters over one or more points of the flight envelope. It will be appreciated that other “correlators” besides the fan speed can be used for converting reference operating parameters 506 to target operating parameters 526. For example, extracted torque or power could be used as a correlator.

For this particular point of the flight envelope, the remaining reference operating parameters 506 (i.e., the reference altitude Alt_{R}, the reference Mach number Mach_{R}, and the reference ambient temperature Amb. T_{R}) can remain the same. The reference operating parameters 506 and the now target fan speed N1_{T} (collectively the target operating parameters 526) can be input into the reference neural network 508 as shown in FIG. 8. One or more processors 332 of one of more computing devices 331 of the engine performance computing system 330 can process the conversions, for example (FIG. 3).

It will be appreciated that more than one reference operating parameter 506 can be converted in a similar manner as described above with regard to the fan speed. For example, where target turbine engines for rotorcraft are considered, a reference requested torque and/or requested power may be converted into a target requested power and/or requested power.

The reference operating parameters 506 can be converted to target operating parameters 526 by any number of statistical or machine-learning models or techniques. In some embodiments, for example, a regression analysis can be used to convert the reference operating parameters 506 into target operating parameters 526. In some embodiments, target operating parameters 526 can be inferred or approximated by one or more extrapolation and/or interpolation techniques based at a least in part on known reference operating parameters 506 and their relationships for one or more points over the flight envelope.

After the reference data set 504 is converted into the target data set 524, at least a portion of the target data set 524 is input into the reference neural network 508. As shown, the target operating parameters 526 of the target data set 524 are input into the input layer of the reference neural network 337.

Thereafter, one or more target performance indicators 530 indicative of the steady-state performance of the target turbine engine 520 are received or generated as an output of the reference neural network 337. Exemplary performance indicators include a target HP compressor discharge temperature T30_{T}, a HP turbine inlet pressure P40_{T}, and a core speed N2_{T}. One or more of the computing devices 331 of the engine performance computing system 330 can receive and/or generate the target performance indicators 530 (FIG. 3).

The outputs of the reference neural network 508 can be used for target analytics 532, such as e.g., a lifing model, a damage model, low cycle fatigue (LCF) models, high cycle fatigue (HCF) models, thermo-mechanical fatigue (TMF), creep, rupture, corrosion, etc. And based on the outputs of these target analytics 532, design improvements and changes can be made as necessary to the target turbine engine 520 much earlier in the design process, among other benefits.

In some exemplary implementations, the reference neural network 508 can be trained or retrained as a target neural network 528. To train the reference neural network 508 into a target neural network 528, one or more supervised training techniques can be used as described above. Particularly, as data from the target turbine engine 520 becomes available, this data can be used to train or retrain the reference neural network 508 into a target neural network 528.

In one example, a data set that includes operating parameters indicative of the operating conditions of the target turbine engine 520 during operation can be fed into a steady-state cycle deck configured to model the steady-state performance of the now-fielded target turbine engine 520. The cycle deck inputs (i.e., the operating parameters associated with a particular point over the flight envelope) and the cycle deck output or outputs corresponding to those inputs can be used as a training data set and may be partitioned further into a validation data set. The training/validation data sets can be used to train or retrain the reference neural network 508 continuously or at certain intervals such that the reference neural network 508 is trained as the target neural network 528.

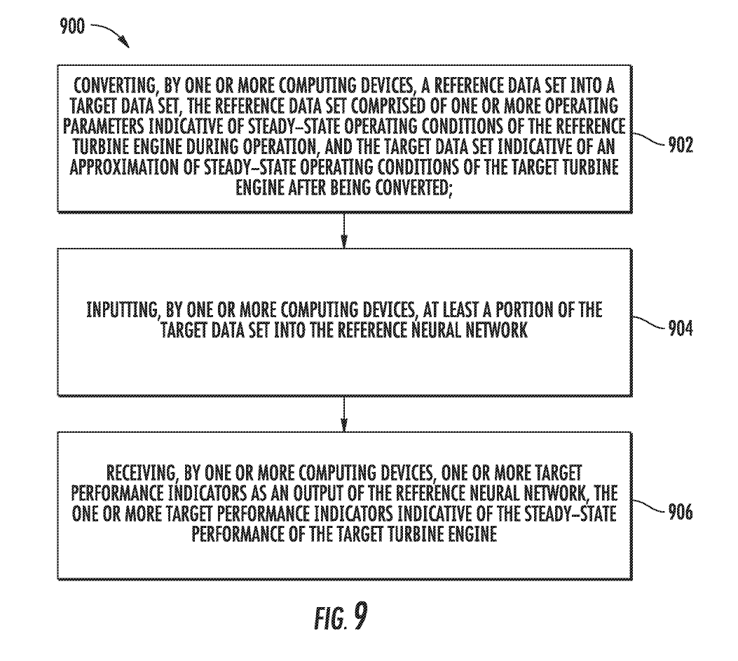

FIG. 9 depicts a flow diagram of an exemplary method (900) for approximating the steady-state performance of a target turbine engine based at least in part on a reference neural network configured to approximate the steady-state performance of a reference turbine engine according to exemplary embodiments of the present disclosure. Some or all of the method (900) can be implemented by one of the computing device(s) 331 of engine performance computing system 330 described herein or any other computing devices of computing system 300. In addition, FIG. 9 depicts method (900) in a particular order for purposes of illustration and discussion. It will be appreciated that exemplary method (900) can be modified, adapted, expanded, rearranged and/or omitted in various ways without deviating from the scope of the present subject matter.

At (902), exemplary method (900) includes converting, by one or more computing devices, a reference data set 504 into a target data set 524, the reference data set 504 includes one or more operating parameters 506 indicative of steady-state operating conditions of the reference turbine engine 500 during operation, and the target data set 524 is indicative of an approximation of steady-state operating conditions of the target turbine engine 520 after being converted. In some implementations, the target turbine engine 520 is a non-fielded, virtual engine.

At (904), exemplary method (900) includes inputting, by one or more computing devices, at least a portion of the target data set 524 into the reference neural network 508.

At (906), exemplary method (900) includes receiving, by one or more computing devices, one or more target performance indicators 530 as an output of the reference neural network 508, the one or more target performance indicators 530 indicative of the steady-state performance of the target turbine engine 520.

In some exemplary embodiments, the reference neural network 508 can be trained or retrained as a target neural network 528. To train the reference neural network 508 into a target neural network 528, one or more supervised training techniques can be used. Particularly, as data from the target turbine engine 520 becomes available, this data can be used to train or retrain the reference neural network 508 into a target neural network 528.

The technology discussed herein makes reference to computing devices, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, computer-implemented processes discussed herein can be implemented using a single computing device or multiple computing devices working in combination. Databases and applications can be implemented on a single system or distributed across multiple systems. Distributed components can operate sequentially or in parallel. Furthermore, computing tasks discussed herein as being performed at computing device(s) remote from the vehicle can instead be performed at the vehicle (e.g., via the vehicle computing system), or vice versa. Such configurations can be implemented without deviating from the scope of the present disclosure.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they include structural elements that do not differ from the literal language of the claims or if they include equivalent structural elements with insubstantial differences from the literal language of the claims.

What is claimed is:

1. A computer-implemented method for steady-state performance approximation of a turbine engine, the method comprising:
receiving, by one or more computing devices, a data set comprised of one or more operating parameters indicative of the operating conditions of the turbine engine during operation;
inputting, by the one or more computing devices, at least a portion of the data set into a neural network; and
receiving, by the one or more computing devices, one or more performance indicators of the turbine engine as an output of the neural network, wherein the neural network is configured to approximate the steady-state performance of the turbine engine.

2. The computer-implemented method of claim 1, wherein the neural network is trained based at least in part on a training data set of a steady-state cycle deck.

3. The computer-implemented method of claim 2, wherein the steady-state cycle deck is a physics-based model.

4. The computer-implemented method of claim 2, wherein the neural network is trained based at least in part on the training data set of the steady-state cycle deck by:
inputting, by the one or more computing devices, at least a portion of the training data set into the neural network, the training data set indicative of steady-state operating conditions of the turbine engine during operation, the training data set comprised of one or more cycle deck inputs and one or more cycle deck outputs of the steady-state cycle deck, each of the cycle deck outputs corresponding to one or more of the cycle deck inputs;
receiving, by the one or more computing devices, one or more performance indicators of the turbine engine as an output of the neural network, and
training, by the one or more computing devices, the neural network based at least in part on an error delta that describes a difference between the output of the neural network and the cycle deck output that corresponds to one or more of the cycle deck inputs input into the neural network.

5. The computer-implemented method of claim 1, wherein the one or more operating parameters include at least one of: a fan speed, an altitude, an ambient temperature, and a Mach number.

6. The computer-implemented method of claim 1, wherein the turbine engine is mounted to or integral with a rotorcraft, and wherein the one or more operating parameters include at least one of: a forward air speed, a requested torque, and a requested power.

7. The computer-implemented method of claim 1, wherein the one or more performance indicators include at least one of: a mass flow, one or more station temperatures, one or more station pressures, and a core speed.

8. The computer-implemented method of claim 1, wherein after receiving the one or more performance indicators of the turbine engine as an output of the neural network, the method further comprises:
providing, by the one or more computing devices, the one or more performance indicators to a damage model.

9. The computer-implemented method of claim 1, wherein the turbine engine is mounted to or integral with an aircraft, and wherein after receiving the one or more performance indicators of the turbine engine as an output of the neural network, the method further comprises:
providing, by the one or more computing devices, the one or more performance indicators to a vehicle computing device located onboard the aircraft.

10. A computer-implemented method for training a neural network configured to approximate the steady-state performance of a turbine engine, the method comprising:
inputting, by the one or more computing devices, at least a portion of a training data set into a neural network, the training data set indicative of steady-state operating conditions of the turbine engine during operation, the training data set comprised of one or more cycle deck inputs and one or more cycle deck outputs of a steady-state cycle deck, each of the cycle deck outputs corresponding to one or more of the cycle deck inputs;
receiving, by the one or more computing devices, one or more performance indicators of the turbine engine as an output of the neural network, wherein the output of the neural network is configured to approximate the steady-state performance of the turbine engine; and
training, by the one or more computing devices, the neural network based at least in part on an error delta that describes a difference between the output of the neural network and the cycle deck output that corresponds to one or more of the cycle deck inputs input into the neural network.

11. The computer-implemented method of claim 10, wherein after training, the method is repeated at least until the error delta that describes a difference between the output of the neural network and the cycle deck output that corresponds to one or more of the cycle deck inputs is about within a threshold percentage.

12. The computer-implemented method of claim 11, wherein the threshold percentage is plus or minus one (1) percent.

13. The computer-implemented method of claim 10, wherein after training, the method further comprises:
receiving, by one or more computing devices, a validation data set indicative of steady-state operating conditions of the turbine engine during operation, the validation data set comprised of one or more cycle deck inputs and one or more cycle deck outputs of the steady-state cycle deck, each of the cycle deck outputs corresponding to one or more of the cycle deck inputs;
inputting, by the one or more computing devices, at least a portion of the cycle deck inputs of the validation data set into the neural network;
receiving, by the one or more computing devices, one or more performance indicators of the turbine engine as an output of the neural network;
determining, by the one or more computing devices, an error delta that describes a difference between the output of the neural network and the cycle deck output that corresponds to one or more of the cycle deck inputs of the validation data set input into the neural network; and
determining, by the one or more computing devices, whether the error delta that describes a difference between the output of the neural network and the cycle deck output that corresponds to one or more of the cycle deck inputs is about within a threshold percentage.

14. The computer-implemented method of claim 15, wherein the neural network comprises an input layer, a hidden layer comprising one or more hidden layer nodes, and an output layer; and wherein, if the error delta is not about within the threshold percentage, the method further comprises:
adjusting, by one or more computing devices, the number of the one or more hidden layer nodes.

15. The computer-implemented method of claim 10, wherein the cycle deck inputs are comprised of one or more operating parameters, wherein the one or more operating parameters include at least one of: a fan speed, an altitude, an ambient temperature, a Mach number, a forward air speed, a requested torque, and a requested power.

16. A method for approximating the steady-state performance of a target turbine engine based at least in part on a reference neural network configured to approximate the steady-state performance of a reference turbine engine, the method comprising:
converting, by one or more computing devices, a reference data set into a target data set, the reference data set comprised of one or more operating parameters indicative of steady-state operating conditions of the reference turbine engine during operation, and the target data set indicative of an approximation of steady-state operating conditions of the target turbine engine after being converted;
inputting, by one or more computing devices, at least a portion of the target data set into the reference neural network; and
receiving, by one or more computing devices, one or more target performance indicators as an output of the reference neural network, the one or more target performance indicators indicative of the steady-state performance of the target turbine engine.

17. The method of claim 16, wherein the target turbine engine is a non-fielded turbine engine.

18. The method of claim 16, wherein the maximum thrust of the target turbine engine is about within 20,000 lb_{f} of the maximum thrust of the reference turbine engine.

19. The method of claim 16, wherein the maximum thrust of the target turbine engine is about within 15,000 lb_{f} of the maximum thrust of the reference turbine engine.

20. The method of claim 16, wherein the maximum thrust of the target turbine engine is about within 10,000 lb_{f} of the maximum thrust of the reference turbine engine.
